(19) United States
(12) Patent Application Publication
(10) Pub. No.: US 2015/0160890 A1
(43) Pub. Date: Jun. 11, 2015

(54) MEMORY MULTI-CHIP PACKAGE (MCP) WITH INTEGRAL BUS SPLITTER

(71) Applicant: Apple Inc., Cupertino, CA (US)

(72) Inventors: Gil Semo, Tel Aviv (IL); Asaf Bart, Petach-Tikva (IL); Avraham Poza Meir, Rishon Le-Zion (IL)

(21) Appl. No.: 14/457,237

(22) Filed: Aug. 12, 2014

Related U.S. Application Data
(60) Provisional application No. 61/912,190, filed on Dec. 5, 2013.

(51) Int. Cl. G06F 3/06; G06F 12/02

(52) U.S. Cl. CPC G06F 3/0659; G06F 12/0246; G06F 3/0619; G06F 3/0688; G06F 2212/7208

(57) ABSTRACT

A device includes multiple memory devices, a bus splitter and a package. The bus splitter is configured to exchange storage commands and data with an external host using an external Input/Output (I/O) bus, and to distribute the storage commands and the data over multiple buses connected to respective subsets of the memory devices, so as to relay the storage commands and the data between the multiple memory devices and the external host. The memory devices and the bus splitter are contained in the package, in a multi-chip package (MCP) structure.

### CROSS-REFERENCE TO RELATED APPLICATIONS

This application claims the benefit of U.S. Provisional Patent Application 61/912,190, filed Dec. 5, 2013, whose disclosure is incorporated herein by reference.

### FIELD OF THE INVENTION

The present invention relates generally to memory devices, and particularly to methods and systems for interfacing with memory devices.

### BACKGROUND OF THE INVENTION

Some memory systems (e.g., Solid State Drives—SSDs) achieve high storage capacity by using multiple non-volatile memory devices (e.g., NAND Flash devices) that are packaged in a Multi-Chip Package (MCP). Such a system typically comprises a host (e.g., SSD controller) that communicates with the memory devices in the MCP over a single Input/Output (I/O) bus.

U.S. Patent Application Publication 2013/0254473, whose disclosure is incorporated herein by reference, describes a method and system for implementing enhanced memory performance management with configurable bandwidth versus power usage in a chip stack of memory chips. U.S. Pat. No. 5,822,251, whose disclosure is incorporated herein by reference, describes expandable flash-memory mass-storage using shared buddy lines and intermediate flash-bus between device-specific buffers and flash-intelligent direct memory access (DMA) controllers.

U.S. Pat. No. 8,463,979, whose disclosure is incorporated herein by reference, describes non-volatile storage devices and methods capable of achieving large capacity solid state drives containing multiple banks of memory devices. U.S. Pat. No. 8,271,723, whose disclosure is incorporated herein by reference, describes systems and methods for coupling multiple Flash devices to a shared bus utilizing isolation switches within a SSD device.

### SUMMARY OF THE INVENTION

An embodiment of the present invention that is described herein provides a device including multiple memory devices, a bus splitter and a package. The bus splitter is configured to exchange storage commands and data with an external host using an external Input/Output (I/O) bus, and to distribute the storage commands and the data over multiple buses connected to respective subsets of the memory devices, so as to relay the storage commands and the data between the multiple memory devices and the external host. The memory devices and the bus splitter are contained in the package, in a multi-chip package (MCP) structure.

In some embodiments, the memory devices include non-volatile memory devices. In other embodiments, the device includes a memory controller, which is packaged with the memory devices and the bus splitter in the package and is configured to exchange the storage commands and the data with the external host. In yet other embodiments, the device includes multiple bus splitters, wherein each bus splitter is connected to at least one of the memory devices.

In an embodiment, the external I/O bus is based on a NAND interface. In another embodiment, error correction coding (ECC) and storage management tasks relating to the storage commands are performed in the external host. In yet another embodiment, ECC and storage management tasks relating to the storage commands are performed in the memory devices.

In some embodiments, the bus splitter includes a multiplexer and control circuitry, the multiplexer is configured to select a bus from among the multiple buses, and the control circuitry is configured to decode the storage commands exchanged with the external host and to control the multiplexer based on the decoded storage commands.

There is additionally provided, in accordance with an embodiment of the present invention, a method including, in an MCP that includes a bus splitter and multiple memory devices, exchanging storage commands and data with an external host, using an external I/O bus. The storage commands and the data are distributed over multiple buses using the bus splitter to respective subsets of the memory devices, and the storage commands and the data are relayed between the multiple memory devices and the external host.

There is further provided, in accordance with an embodiment of the present invention, a method including providing multiple memory devices, a bus splitter device, and a package containing the multiple memory devices and the bus splitter device in a multi-chip package (MCP) structure. The bus splitter device is connected, using buses, to respective subsets of the memory devices, and is also connected to an external I/O bus, so as to relay storage commands and data between the memory devices and an external host.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment of the present invention.

### DETAILED DESCRIPTION OF EMBODIMENTS

### Overview

When multiple non-volatile memory devices (e.g., Flash) are connected in parallel to a single, common Input/Output (I/O) bus, the capacitive load on the I/O bus may degrade the integrity of signals transferred on the bus. This degradation may be a limiting factor to obtain a higher bus speed, and thus slowing a storage throughput of a given system.

Embodiments of the present invention that are described herein provide improved methods and systems for interfacing between a host and multiple memory devices. In the disclosed embodiments, the MCP further comprises a bus splitter that splits the I/O bus into multiple buses connected to the memory devices. The bus splitter relays storage commands and data between the memory devices and the host, such that at any given time only a small number of memory devices (or even a single memory device) are connected to the bus.

As a result, capacitive load is reduced, and higher bus speed can be obtained while maintaining high integrity of the signals transferred on the bus. Moreover, packaging the bus splitter together with the memory devices in the same MCP shortens the interconnections between the bus splitter and the memory devices and thus improves performance. Furthermore, since the bus splitter is packaged internally in the MCP (as opposed to using an external bus splitter) the disclosed configurations reduce the device footprint and do not increase the MCP pin-count.

### System Description

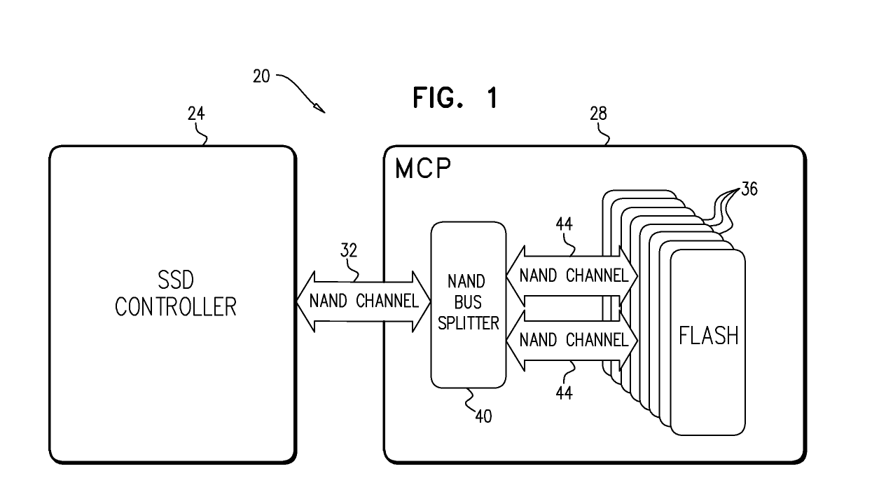

FIG. 1 is a block diagram that schematically illustrates a memory system 20, in accordance with an embodiment of the present invention. Memory system 20 can be used in various host systems and devices, such as in computing devices, cellular phones or other communication terminals, removable memory modules (sometimes referred to as “USB Flash Drives”), Solid State Disks (SSD), digital cameras, media players and/or any other system or device in which data is stored and retrieved.

Memory system 20 comprises a host, in the present example an SSD controller 24, which stores data in a MCP 28. The SSD controller communicates with MCP 28 over an external I/O bus 32, which is typically used for transferring both commands and data. In the present example, bus 32 uses the NAND interface, or at least based on the NAND interface, and is therefore referred to as a NAND channel. The NAND interface, however, is chosen purely by way of example. In alternative embodiments, bus 32 may use any other suitable protocol.

MCP 28 comprises multiple memory devices, in the present example NAND Flash memory devices 36 in which the data is stored. In other embodiments MCP 28 may comprise any other suitable type, or a combination of different types, of multiple non-volatile memory devices.

In the example shown in FIG. 1, MCP 28 further comprises a bus splitter 40. Bus splitter 40 splits the communication on external I/O bus 32 among two or more buses 44, which are connected to memory devices 36. Bus splitting of this sort reduces the capacitive load on external I/O bus 32 and on buses 44, so that signal integrity degradation is reduced. As a result, higher bus speeds can be used.

Typically, bus splitter 40 is fabricated on a semiconductor die that is packaged in MCP 28, i.e., in the same device package together with memory devices 36. Depending on the specific MCP fabrication process, bus splitter 40 and memory devices 36 may be mounted on a common substrate, connected by buses 44 (e.g., using wire-bonding, Through-Silicon-Vias (TSV), Multi-Chip Module (MCM), stacked die, System-in-Package (SiP), or any other suitable packaging technology), and packaged in a single device package.

From the point of view of SSD controller 24, the interface with MCP 28 is over a single external I/O bus 32. Internally in the MCP, however, the commands and data exchanged between SSD controller 24 and memory devices 36 are distributed by bus splitter 40 to buses 44 as appropriate. In an embodiment, when SSD controller 24 selects a certain memory device 36, bus splitter 40 switches to a pertinent bus 44, which is connected to that memory device. The other buses 44 remain disconnected.

Bus splitter 40 may be controlled in various ways, either by SSD controller 24 or by internal circuitry in MCP 28. In some embodiments, the bus splitter comprises an analog multiplexer (MUX) that is controlled using Chip Enable (CE) and Read/Write (RD/WR) signals.

In alternative embodiments, bus splitter 40 comprises a digital MUX, and MCP 28 comprises control circuitry that controls the MUX. The control circuitry decodes the storage commands arriving from the SSD controller, and selects the appropriate bus 44 based on the commands. In an example embodiment, the control circuitry decodes the address of a given command, identifies the bus 44 over which the command is to be executed (i.e., the bus 44 that serves the memory device 36 in which the command is to be executed), and switches the digital MUX to select this bus.

The two control schemes above are examples, chosen purely for the sake of conceptual clarity. In alternative embodiments, bus splitter 40 may be controlled in any other suitable manner.

Typically, execution of a programming command involves error correction coding (ECC) and storage management tasks. In some embodiments, the ECC and storage management tasks are performed in SSD controller 24, which subsequently sends the programming command, via bus 32 and bus splitter 40, to devices 36, which store the data. In alternative embodiments, controller 24 sends the programming command to devices 36, which perform the ECC and storage management tasks before storing the data.

Similarly, executing a read command typically involves ECC decoding and storage management tasks. Accordingly, in some embodiments, the ECC decoding and storage management tasks of the stored data are performed in devices 36 before providing the requested data to controller 24. In other embodiments, controller 24 reads the stored data from devices 36, and then performs the ECC decoding and storage management tasks for the stored data.

The configuration of FIG. 1 is an exemplary system configuration, which is shown purely for the sake of conceptual clarity. Any other suitable memory system configuration can also be used. MCP 28 may comprise any suitable number of memory devices 36. Although the embodiments described herein refer mainly to Flash memory, embodiments of the disclosed techniques can be used with any other suitable type of memory.

In various embodiments, MCP 28 may comprise any suitable number of buses 44, and any suitable assignment of buses 44 to memory devices 36. In one example embodiment, each memory device 36 is connected to bus splitter 40 using a separate respective bus 44. In other embodiments, memory devices 36 are divided into two or more groups, and each group is connected to bus splitter 40 using a separate respective bus 44. These options enable different trade-offs between circuit complexity and signal integrity (and thus throughput).

Although the example of FIG. 1 shows a single bus splitter 40, for the sake of clarity, in alternative embodiments MCP 28 may comprise multiple bus splitters 40. For example, multiple bus splitters can be cascaded in a hierarchical structure. In an example embodiment, one bus splitter may split I/O bus 32 into two intermediate buses, and two additional bus splitters may split the respective intermediate buses into multiple individual buses 44. In alternative embodiments, two or more bus splitters may be connected in parallel to bus 32, with each bus splitter connected to a respective subset of buses 44. For example, 1:4 splitting may be performed by connecting two 1:2 bus splitters in parallel to bus 32, with each bus splitter connected to two respective buses 44.

Elements that are not necessary for understanding the principles of the present invention, such as various interfaces, addressing circuits, timing and sequencing circuits and debugging circuits, have been omitted from the figure for clarity. In the exemplary system configuration shown in FIG. 1, MCP 28 and SSD controller 24 are implemented as two separate Integrated Circuits (ICs). In alternative embodiments, however, the SSD controller may be integrated in MCP 28, as well. Further alternatively, some or all of the functionality of SSD controller 24 can be implemented in software and carried out by a processor or other element of a host system.

In some embodiments, SSD controller 24 comprises a general-purpose processor, which is programmed in software to carry out the functions described above. The software may be downloaded to the processor in electronic form, over a network, for example, or it may, alternatively or additionally, be provided and/or stored on non-transitory tangible media, such as magnetic, optical, or electronic memory.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A device, comprising:
multiple memory devices;
a bus splitter, which is configured to exchange storage commands and data with an external host using an external Input/Output (I/O) bus, and to distribute the storage commands and the data over multiple buses connected to respective subsets of the memory devices, so as to relay the storage commands and the data between the multiple memory devices and the external host; and
a package, which packages the memory devices and the bus splitter in a multi-chip package (MCP) structure.

2. The device according to claim 1, wherein the memory devices comprise non-volatile memory devices.

3. The device according to claim 1, and comprising a memory controller, which is packaged with the memory devices and the bus splitter in the package of the MCP structure, and which is configured to exchange the storage commands and the data with the external host.

4. The device according to claim 1, and comprising multiple bus splitters, wherein each bus splitter is connected to at least one of the memory devices.

5. The device according to claim 1, wherein the external I/O bus is based on a NAND interface.

6. The device according to claim 1, wherein error correction coding (ECC) and storage management tasks relating to the storage commands are performed in the external host.

7. The device according to claim 1, wherein error correction coding (ECC) and storage management tasks relating to the storage commands are performed in the memory devices.

8. The device according to claim 1, wherein the bus splitter comprises:
a multiplexer, which is configured to select a bus from among the multiple buses; and
control circuitry, which is configured to decode the storage commands exchanged with the external host and to control the multiplexer based on the decoded storage commands.

9. A method, comprising:
in a multi-chip package (MCP), which comprises a bus splitter and multiple memory devices, exchanging storage commands and data with an external host, using an external Input/Output (I/O) bus;
distributing the storage commands and the data over multiple buses using the bus splitter to respective subsets of the memory devices; and
relaying the storage commands and the data between the multiple memory devices and the external host.

10. The method according to claim 9, wherein the memory devices comprise non-volatile memory devices.

11. The method according to claim 9, wherein relaying the storage commands and the data comprises transferring the storage commands and the data between the external host and a memory controller, which is packaged in the package with the memory devices and the bus splitter.

12. The method according to claim 9, wherein distributing the storage commands and the data comprises transferring the storage commands and the data using multiple bus splitters, wherein each bus splitter is connected to at least one of the memory devices.

13. The method according to claim 9, wherein the external I/O bus comprises at least a NAND interface.

14. The method according to claim 9, wherein the exchanging storage commands and data, comprises performing error correction coding (ECC) and storage management tasks relating to the storage commands, in the external host.

15. The method according to claim 9, wherein the exchanging storage commands and data, comprises performing error correction coding (ECC) and storage management tasks relating to the storage commands, in the memory devices.

16. The method according to claim 9, wherein distributing and relaying the storage commands and the data comprise decoding the storage commands exchanged with the external host, and controlling the bus splitter based on the decoded storage commands.

17. A method, comprising:
providing multiple memory devices;
providing a bus splitter device;
packaging the multiple memory devices and the bus splitter device in a multi-chip package (MCP) structure; and
connecting the bus splitter device using buses to respective subsets of the memory devices, and connecting the bus splitter device to an external Input/Output (I/O) bus, so as to relay storage commands and data between the memory devices and an external host.

18. The method according to claim 17, wherein the memory devices comprise non-volatile memory devices.

19. The method according to claim 17, and comprising packaging a memory controller with the memory devices and the bus splitter, in the package of the MCP structure.

20. The method according to claim 17, wherein providing and packaging the bus splitter device comprise providing and packaging multiple bus splitters, and wherein connecting the bus splitter device to the memory devices comprises connecting each bus splitter to at least one of the memory devices.
